(19) United States
(12) Patent Application Publication
(10) Pub. No.: US 2004/0148407 A1
(43) Pub. Date: Jul. 29, 2004

(54) Coupling selection/configuration through service parameters

(75) Inventors: Lieven Leopold Albertine Trappeniers, Herentals (BE); Rudolph Henri Adriaan Siebelink, Antwerp (BE); Harald Einte Holwerda, Voorburg (NL)

Correspondence Address: SUGHRUE MION, PLLC, 2100 Pennsylvania Avenue, N.W., Washington, DC, 20037-3213, US

(73) Assignee: ALCATEL

(21) Appl. No.: 10/736,634

(22) Filed: Dec. 17, 2003

(30) Foreign Application Priority Data
Dec. 19, 2002 (EP) 02293155.4

(51) Int. Cl. G06F 15/16

(52) U.S. Cl. 709/228; 709/226

(57) ABSTRACT

The communication via couplings (3) for providing services defined by service parameters like video-on-demand services and audio/video calls and voice-over-internet-protocol calls and via an access system (4) for accessing a network (5) can be done more dynamically and efficiently (insight) by (basic idea) introducing service-selection-signals, service-definition-signals, service-information-signals, and by configuring terminals (1) and/or coupling-interfaces (2) and couplings (3) and the access system (4). Then users get the option of selecting one out of many services, a service-selection-server (9) coupled to and/or forming part of the access system (4) gets the service-definition-signals like for example service parameters, and couplings (3) and the access system (4) and terminals (1) and/or coupling-interfaces (2) are configured to be in conformance with said service-definition-signals. Terminals (1) are informed through service-information-signals, defining the coupling (3) to be used. Finally, said communication takes place for providing said services.

The invention relates to a method for communication between a terminal with a coupling-interface and a providing-server via couplings for providing services defined by service parameters and via an access system for accessing a network.

For example in case of a video-on-demand service, said providing-server for example corresponds with a content provider's server, and for example in case of an audio/video call or a voice-over-internet-protocol call, said providing-server for example corresponds with an other terminal etc. Said terminal for example corresponds with a personal computer etc. and said coupling-interface for example corresponds with a Digital-Subscriber-Line-Access-Multiplexer etc. and said access system for example corresponds with a Broadband-Remote-Access-Server etc.

A prior art system is known from U.S. Pat. No. 6,453,349, which discloses an apparatus and method for resource reservation in a network system. Through reservation messages and acknowledge messages, terminals can make reservations for network resources like for example bandwidth, delay, jitter etc.

The known system is disadvantageous, inter alia, due to once a reservation for a communication has been made, during this communication, the reservation parameters keep their values statically, and the network handles all traffic based upon these static parameters inefficiently, due to not taking into account that the amount of resources required per communication may fluctuate.

It is an object of the invention, inter alia, of providing a method as defined in the preamble which is more dynamical and efficient.

The method according to the invention is characterised in that said method comprises the steps of

(a) at said terminal, generating a service-selection-signal and transmitting said service-selection-signal from said terminal to a service-selection-server,

(b) at said service-selection-server, in dependence of a service-definition-signal, generating a configuration-signal and transmitting said configuration-signal to said access system for configuring at least parts of said access system and at least parts of said couplings,

(c) at said service-selection-server, generating a service-information-signal and transmitting said service-information-signal to said terminal and/or said coupling-interface, and

(d) at said terminal and/or said coupling-interface, communicating with said providing-server via at least one coupling defined by at least one service parameter.

By introducing step (a), a user at the terminal has got the option of selecting one out of many services, like for example surfing the web, making a telephone call, ordering pay-tv-channels etc. Then, with step (b), parts of the access system, like for example modems, filters, (de)modulators, (de)converters etc. and parts of packet-switched-couplings like for example Asynchronous-Transfer-Mode-Pipes, Multi-Protocol-Label-Switching pipes, Internet-Protocol-couplings etc. are configured to be in conformance with said service-definition-signal. Thereby, said configuration-signal may correspond with said service-definition-signal or not and may comprise parts of said service-definition-signal or not. By introducing step (c), the terminal and/or the coupling-interface is/are informed through the service-information-signal, which for example defines the coupling etc. to be used. Finally, with step (d), communication takes place via the coupling defined by a service parameter. Said service-selection-server either is coupled to said access system via said network or via said couplings or via another coupling, or forms part of said access system. When forming part of said access system, said service-selection-server may be a separate part of said access system or may be fully integrated with said access system.

By means of said service-selection-signal, said service-definition-signal, said configuring and said service-information-signal, services can be selected dynamically and are specified dynamically (by the service-definition-signal), and the networks are used efficiently (said configuring allows for example couplings etc. to be adapted with respect to bandwidth, delay, jitter, priority etc.), with the service-information-signal being used for informing the terminal and/or the coupling-interface dynamically and for increasing the efficiency of the terminal and/or the coupling-interface. Said couplings may be packet/cell/frame switched couplings and/or Asynchronous Transfer Mode couplings or other couplings etc.

A first embodiment of the method according to the invention is defined by claim 2.

With step (b) comprising the step (b1), the service-selection-server retrieves the service-definition-signal like for example one or more service parameters like for example bandwidth, delay, jitter, priority etc. from a database forming part of said service-selection-server or being near said service-selection-server. In this case said providing-server may correspond with said terminal or said content provider's server etc.

A second embodiment of the method according to the invention is defined by claim 3.

With step (b) comprising the step (b2), the service-selection-server retrieves the service-definition-signal like for example one or more service parameters like for example bandwidth, delay, jitter, priority etc. from said providing-server this time corresponding with the content provider's server etc. Thereby, either said service-selection-signal is forwarded to said providing-server, which in response sends said service-definition-signal to said service-selection-server, or said service-selection-signal is sent to said service-selection-server, which in response consults said providing-server for example by sending a request signal etc.

A third embodiment of the method according to the invention is defined by claim 4.

In case of said coupling-interface being coupled to said access system via a permanent channel, with said step (d1), parts of the terminal like for example modems, filters, (de)modulators, (de)converters etc. and parts of said coupling-interface like for example modems, filters, (de)modulators, (de)converters etc. are configured to be in conformance with said service-definition-signal. Said service parameter can be supplied to said terminal and/or coupling-interface via said service-information-signal. With step (d2), a virtual connection from said coupling-interface to said access system is set up, and with step (d3), a virtual connection from said access system to said providing-server is set up. Said permanent channel for example corresponds with a so-called always-on channel like the D-channel of an Integrated-Service-Digital-Network etc. and may coincide with said couplings or not.

A fourth embodiment of the method according to the invention is defined by claim 5.

In case of said coupling-interface not being coupled to said access system via a permanent channel, with said step (a1), in dependence of said service-selection-signal, a virtual connection from said coupling-interface to said service-selection-server is set up, and with step (a2), parts of said terminal like for example modems, filters, (de)modulators, (de)converters etc. and parts of said coupling-interface like for example modems, filters, (de)modulators, (de)converters etc. are configured to be in conformance with said service-selection-signal (which for example refers to an old service-definition-signal used before or to a predefined service-definition-signal to be used for said setting up etc.). Said service parameter is prestored in said terminal and/or said coupling-interface. With said step (d3), a virtual connection from said access system to said providing-server is set up.

A fifth embodiment of the method according to the invention is defined by claim 6.

With said step (d4), in dependence of said service-information-signal, said parts of said terminal and/or of said coupling-interface can now be re-configured (for example to adapt said old service-definition-signal used before or said predefined service-definition-signal to be used for said setting up etc.).

A sixth embodiment of the method according to the invention is defined by claim 7.

By introducing the billing at said access system of packet-signals (to be) exchanged between said terminal and/or of said coupling-interface on the one hand and said providing-server on the other hand, the dynamic and efficient behaviour will result in dynamic and efficient bills.

The invention also relates to an access system for performing a method for communication between a terminal with a coupling-interface and a providing-server via couplings for providing services defined by service parameters and via said access system for accessing a network, which access system comprises an access processor-system for controlling an access tranceiver for transmitting and receiving signals.

The access system according to the invention is characterised in that said access processor-system comprises

(a) a receiving processor-system-part for receiving a configuration-signal from said service-selection-server, and

(b) a configuring processor-system-part for, in dependence of said configuration-signal, configuring at least parts of said access system and at least parts of said couplings.

The invention yet also relates to an access processor program product to be run via an access processor-system for controlling an access tranceiver for transmitting and receiving signals and for use in an access system for performing a method for communication between a terminal with a coupling-interface and a providing-server via couplings for providing services defined by service parameters and via said access system for accessing a network.

The access processor program product according to the invention is characterised in that said access processor program product comprises the functions of

(a) receiving a configuration-signal from said service-selection-server, and

(b) in dependence of said configuration-signal, configuring at least parts of said access system and at least parts of said couplings.

The invention too relates to a service-selection-server for performing a method for communication between a terminal with a coupling-interface and a providing-server via couplings for providing services defined by service parameters and via an access system for accessing a network, which service-selection-server comprises a service-selection-server processor-system for controlling a service-selection-server tranceiver for transmitting and receiving signals.

The service-selection-server according to the invention is characterised in that said service-selection-server processor-system comprises

(a) a receiving processor-system-part for receiving a service-selection-signal from said terminal,

(b) a configuring processor-system-part for, in dependence of a service-definition-signal, generating a configuration-signal and transmitting said configuration-signal to said access system for configuring at least parts of said access system and at least parts of said couplings, and

(c) a generating processor-system-part for generating a service-information-signal and transmitting said service-information-signal to said terminal.

The invention yet too relates to a service-selection-server program product to be run via a service-selection-server processor-system for controlling a service-selection-server tranceiver for transmitting and receiving signals and for use in a service-selection-server for performing a method for communication between a terminal with a coupling-interface and a providing-server via couplings for providing services defined by service parameters and via an access system for accessing a network.

The service-selection-server program product according to the invention is characterised in that said service-selection-server program product comprises the functions of

(a) receiving a service-selection-signal from said terminal,

(b) in dependence of a service-definition-signal, generating a configuration-signal and transmitting said configuration-signal to said access system for configuring at least parts of said access system and at least parts of said couplings, and

(c) generating a service-information-signal and transmitting said service-information-signal to said terminal.

The invention further relates to a terminal for performing a method for communication between said terminal with a coupling-interface and a providing-server via couplings for providing services defined by service parameters and via an access system for accessing a network, which terminal comprises a terminal processor-system for controlling a terminal tranceiver for transmitting and receiving signals.

The terminal according to the invention is characterised in that said terminal processor-system comprises

(a) a selecting processor-system-part for generating a service-selection-signal and transmitting said service-selection-signal from said terminal to said service-selection-server,

(c) a receiving processor-system-part for receiving a service-information-signal from said service-selection-server, and

(d) a communicating processor-system-part for communicating with said providing-server via at least one coupling defined by at least one service parameter.

The invention yet further relates to a terminal processor program product to be run via a terminal processor-system for controlling a terminal tranceiver for transmitting and receiving signals and for use in a terminal for performing a method for communication between said terminal with a coupling-interface and a providing-server via couplings for providing services defined by service parameters and via an access system for accessing a network.

The terminal processor program product according to the invention is characterised in that said terminal processor program product comprises the functions of

(a) generating a service-selection-signal and transmitting said service-selection-signal from said terminal to said service-selection-server,

(c) receiving a service-information-signal from said service-selection-server, and

(d) communicating with said providing-server via at least one coupling defined by at least one service parameter.

The invention further also relates to a coupling-interface for performing a method for communication between a terminal with said coupling-interface and a providing-server via couplings for providing services defined by service parameters and via an access system for accessing a network, which coupling-interface comprises a coupling-interface processor-system for controlling a coupling-interface tranceiver for transmitting and receiving signals.

The coupling-interface according to the invention is characterised in that said coupling-interface processor-system comprises

(a) a transceiving processor-system-part for receiving a service-selection-signal from said terminal and transmitting said service-selection-signal to said service-selection-server,

(c) a receiving processor-system-part for receiving a service-information-signal from said service-selection-server, and

(d) a communicating processor-system-part for communicating with said providing-server via at least one coupling defined by at least one service parameter.

The invention yet further also relates to a coupling-interface processor program product to be run via a coupling-interface processor-system for controlling a coupling-interface tranceiver for transmitting and receiving signals and for use in a coupling-interface for performing a method for communication between a terminal with said coupling-interface and a providing-server via couplings for providing services defined by service parameters and via an access system for accessing a network.

The coupling-interface processor program product according to the invention is characterised in that said coupling-interface processor program product comprises the functions of

(a) receiving a service-selection-signal from said terminal and transmitting said service-selection-signal to said service-selection-server,

(c) receiving a service-information-signal from said service-selection-server, and

(d) communicating with said providing-server via at least one coupling defined by at least one service parameter.

And the invention relates to a providing-server for use in a method for communication between a terminal with a coupling-interface and said providing-server via couplings for providing services defined by service parameters and via an access system for accessing a network, which providing-server comprises a providing-server processor-system for controlling a providing-server tranceiver for transmitting and receiving signals.

The providing-server according to the invention is characterised in that said providing-server processor-system comprises

(f1) a receiving processor-system-part for receiving a request signal or a service-selection-signal from a service-selection-server,

(f2) a generating processor-system-part for, in response to said request signal or said service-selection-signal, generating a service-definition-signal,

(f3) a transmitting processor-system-part for transmitting said service-definition-signal to said service-selection-server, and

(f4) a communicating processor-system-part for communicating with said terminal via at least one coupling defined by at least one service parameter.

And yet the invention relates to a providing-server processor program product to be run via a providing-server processor-system for controlling a providing-server tranceiver for transmitting and receiving signals and for use in a providing-server for performing a method for communication between a terminal with a coupling-interface and said providing-server via couplings for providing services defined by service parameters and via an access system for accessing a network.

The providing-server processor program product according to the invention is characterised in that said providing-server processor program product comprises the functions of

(f1) receiving a request signal or said service-selection-signal from a service-selection-server,

(f2) in response to said request signal or said service-selection-signal, generating a service-definition-signal,

(f3) transmitting said service-definition-signal to said service-selection-server, and

(f4) communicating with said terminal via at least one coupling defined by at least one service parameter.

Embodiments of the access system according to the invention and of the access processor program product according to the invention and of the service-selection-server according to the invention and of the service-selection-server program product according to the invention and of the terminal according to the invention and of the terminal processor program product according to the invention and of the coupling-interface according to the invention and of the coupling-interface processor program product according to the invention and of the providing-server according to the invention and of the providing-server processor program product according to the invention correspond with the embodiments of the method according to the invention.

The invention is based upon an insight, inter alia, that prior art services are selected statically and are specified statically, and prior art networks are used inefficiently, and is based upon a basic idea, inter alia, said service-selection-signal, said service-definition-signal, said configuring and said service-information-signal are to be introduced.

The invention solves the problem, inter alia, of providing a more dynamical and more efficient method, and is advantageous, inter alia, in that services can be selected dynamically and are specified dynamically, and the networks are used efficiently, and the terminal and/or the coupling-interface is/are informed dynamically and is/are made more efficient.

These and other aspects of the invention will be apparent from and elucidated with reference to the embodiments(s) described hereinafter.

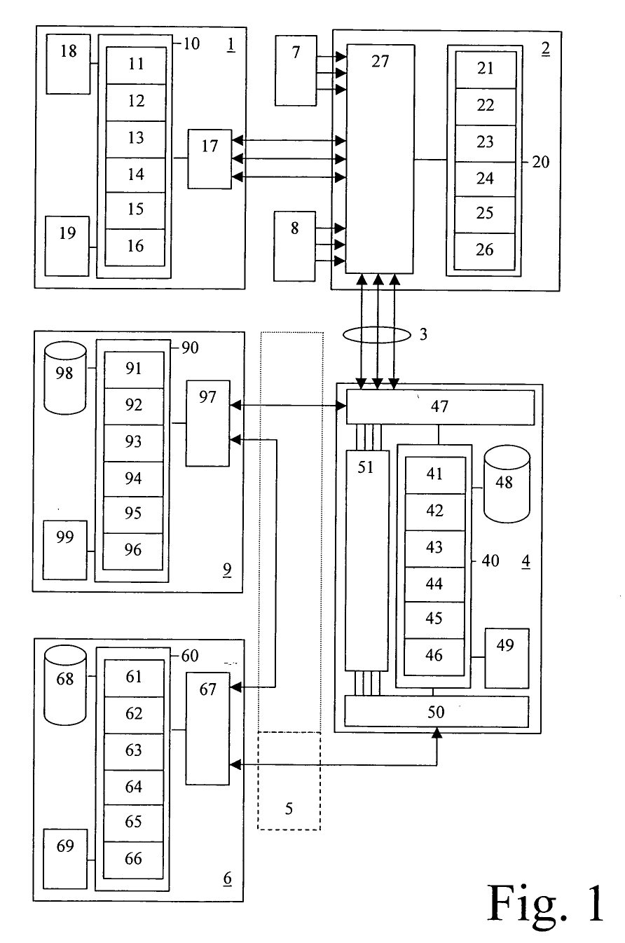

FIG. 1 illustrates in block diagram form a system comprising a terminal according to the invention and a coupling-interface according to the invention and an access system according to the invention and a service-selection-server terminal according to the invention and a providing-server terminal according to the invention, and

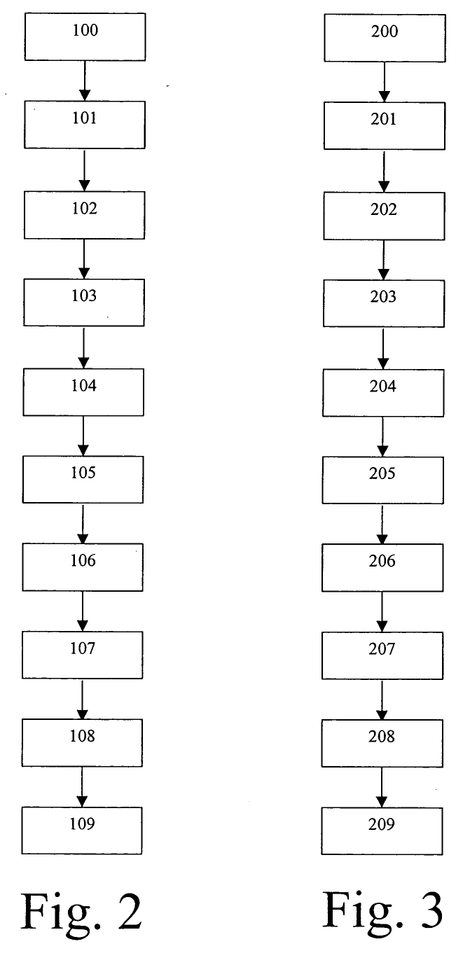

FIG. 2 illustrates in flow chart form a method according to the invention in case of a permanent channel being present between terminal and service-selection-server, and

FIG. 3 illustrates in flow chart form a method according to the invention in case of a permanent channel not being present between terminal and service-selection-server.

The system shown in FIG. 1 like for example a mobile telecommunication system or a fixed telecommunication system etc. comprises terminals 1, 7, 8 coupled to a coupling-interface 2 which is further coupled via couplings 3 to an access system 4 which is further coupled to a providing-server 6 via a network 5 and to a service-selection-server 9. In case of a mobile situation, at least a part of couplings 3 will be wireless couplings, and in case of a fixed situation, at least a part of couplings 3 will be wired couplings.

Terminal 1 comprises a terminal processor-system 10 coupled to an in/output of a terminal transceiver 17 and to a memory 18 and to a man-machine-interface 19 or mmi 19. Processor-system 10 comprises one or more processors and for example processor-system-parts 11-16, with other and further processor-system-parts not to be excluded, and with each processor-system-part 11-16 being 100% hardware, 100% software or a mixture of both. A further in/output of transceiver 17 is coupled via couplings (wired in case of a wired (home)network or wireless in case of a wireless (home)network) to a coupling-interface transceiver 27 of coupling-interface 2. Coupling-interface transceiver 27 is further coupled to terminals 7 and 8 (possibly being similar to terminal 1) and to an access tranceiver 47 via couplings 3. Coupling-interface 2 further comprises a coupling-processor-system 20 which comprises one or more processors and for example processor-system-parts 21-26, with other and further processor-system-parts not to be excluded, and with each processor-system-part 21-26 being 100% hardware, 100% software or a mixture of both.

Access system 4 comprises said access tranceiver 47 which is further coupled to service-selection-server 9 and to an access processor-system 40 comprising one or more processors and for example processor-system-parts 41-46, with other and further processor-system-parts not to be excluded, and with each processor-system-part 41-46 being 100% hardware, 100% software or a mixture of both. Access processor-system 40 is further coupled to a memory 48 and to an interface 49. Access system 4 further comprises a switch 50 (or another forwarding module like for example a bridge or a router etc.) coupled to said access processor-system 40 and via a transceiver-switch-interface 51 to said access transceiver 47. Switch 50 is further coupled via a coupling through network 5 to providing-server 6. Alternatively, providing-server 6 may be coupled to access system 4 via access transceiver 47, and/or access transceiver 47 and switch 50 and transceiver-switch-interface 51 may be completely integrated with each other and form one solitary unit.

For example in case of a video-on-demand service, said providing-server 6 for example corresponds with a content provider's server, and for example in case of an audio/video call or a voice-over-internet-protocol call, said providing-server 6 for example corresponds with an other terminal etc. Said terminals 1, 7, 8 for example correspond each with a personal computer etc. and said coupling-interface 2 for example corresponds with a Digital-Subscriber-Line-Access-Multiplexer etc. and said access system 4 for example corresponds with a Broadband-Remote-Access-Server and parts of couplings 3 for example correspond with Asynchronous-Transfer-Mode-Pipes, Multi-Protocol-Label-Systems, Internet-Protocol-couplings etc.

Providing-server 6 comprises a providing-server processor-system 60 coupled to an in/output of a providing-server transceiver 67 and to a memory 68 and to a man-machine-interface 69 or mmi 69. Processor-system 60 comprises one or more processors and for example processor-system-parts 61-66, with other and further processor-system-parts not to be excluded, and with each processor-system-part 61-66 being 100% hardware, 100% software or a mixture of both. A further in/output of transceiver 67 is coupled via said network 5 to said switch 50, and a yet further in/output of transceiver 67 is coupled to service-selection-server 9.

Service-selection-server 9 comprises a service-selection-server processor-system 90 coupled to an in/output of a service-selection-server transceiver 97 and to a memory 98 and to a man-machine-interface 99 or mmi 99. Processor-system 90 comprises one or more processors and for example processor-system-parts 91-96, with other and further processor-system-parts not to be excluded, and with each processor-system-part 91-96 being 100% hardware, 100% software or a mixture of both. A further in/output of transceiver 97 is coupled to said transceiver 47, and a yet further in/output of transceiver 97 is coupled to said transceiver 67.

In the method according to the invention shown in FIG. 2 in flow chart form for a permanent channel being present between coupling-interface 2 and service-selection-server 9 the blocks have the following meaning: Block 100: A user at terminal 1 selects a service via a service-selection-application in terminal 1.

Block 101: The service-selection-application in terminal 1 informs service-selection-server 9 via the permanent channel.

Block 102: The service-selection-server 9 consults either its own memory or a third party to be reached via couplings 3 or via network 5.

Block 103: The service-selection-server 9 retrieves user data originating from terminal 1 and/or from its own memory and/or from memory 48 and/or from another location to be reached via couplings 3 or via network 5 for authentication and/or authorisation purposes.

Block 104: The service-selection-server 9 configures access system 4 and/or couplings 3 and/or coupling-interface 2 by sending one or more configuration-signals.

Block 105: The service-selection-server 9 informs the service-selection-application in terminal 1 about the configuration via the permanent channel.

Block 106: The service-selection-application in terminal 1 informs the Asynchronous-Transfer-Mode-Termination-Point about the configuration.

Block 107: The Asynchronous-Transfer-Mode-Termination-Point and access system 4 set up one or more virtual connections from terminal 1 to a providing-server 6.

Block 108: The service-selection-application in terminal 1 acknowledges the establishment to the service-selection-server 9.

Block 109: Communication between said terminal 1 and said providing-server 6 is billed.

The method according to the invention shown in FIG. 2 and in view of the system shown in FIG. 1 functions as follows. A user at terminal 1 selects a service via a service-selection-application in terminal 1 and/or coupling-interface 2 (Block 100). This service-selection-application may correspond with for example an application like software running via processor-system 10, or a webpage, or a webpage containing a java applet etc. This service may correspond with for example a video-on-demand service, an audio/video call or a voice-over-internet-protocol call etc. Then the service-selection-application in terminal 1 and/or coupling-interface 2 informs service-selection-server 9 via the permanent channel (Block 101). This service-selection-server 9 may correspond with one of the processors of processor-system 40 or with a separate server coupled to said processor-system 40 (possibly via couplings 3 or network 5) etc. Both blocks 100 and 101 together form step(a) of, at said terminal 1, generating a service-selection-signal and transmitting said service-selection-signal from said terminal 1 to said service-selection-server 9.

The service-selection-server 9 consults either its own memory or a third party located elsewhere (Block 102). This forms step (b1) of, at said service-selection-server 9, in dependence of said service-selection-signal, generating said service-definition-signal, or step (b2) of, at said service-selection-server 9, receiving said service-definition-signal from said providing-server 6 defined by said service-selection-signal, either indirectly via network 5 and access system 4 or directly from providing-server 6 (with said providing-server 6 thereby either being consulted by service-selection-server 9 (via a request signal) or having received for example said service-selection-signal and in response responding with said service-definition-signal). The service-selection-server 9 may further retrieve user data originating from terminal 1 and/or from its own memory and/or from memory 48 and/or from another location for authentication and/or authorisation purposes (Block 103).

Then the service-selection-server 9 configures access system 4 and/or couplings 3 and/or coupling-interface 2 by generating and sending one or more configuration-signals (Block 104). This forms step (b) of, at said service-selection-server 9, in dependence of a service-definition-signal, generating a configuration-signal and transmitting said configuration-signal to said access system 4 for configuring at least parts of said access system 4 and at least parts of said couplings 3 (and/or parts of interface-coupling 2). The service-selection-server 9 informs the service-selection-application in terminal 1 about the configuration via the permanent channel (Block 105). This forms step (c) of, at said service-selection-server 9, generating a service-information-signal and transmitting said service-information-signal to said terminal 1 and/or said coupling-interface 2.

The service-selection-application in terminal 1 may inform the Asynchronous-Transfer-Mode-Termination-Point about the configuration (Block 106). In case of transceiver 17 and/or transceiver 27 comprising an Ethernet modem, the Asynchronous-Transfer-Mode-Layer ends in the modem, and said Asynchronous-Transfer-Mode-Termination-Point corresponds with said modem. In case of said transceiver 17 and/or transceiver 27 comprising a Universal-Serial-Bus-Digital-Subscriber-Line modem, the Asynchronous-Transfer-Mode-Layer ends in the processor-system 10 and/or processor-system 20, and said Asynchronous-Transfer-Mode-Termination-Point corresponds with processor-system 10 and/or processor-system 20.

The Asynchronous-Transfer-Mode-Termination-Point (transceiver 17 and/or 27 and/or processor-system 10 and/or 20) and access system 4 set up one or more virtual connections from terminal 1 and/or coupling-interface 2 via couplings 3 and via access system 4 to providing-server 6 (Block 107), like, in case of a video-on-demand service, a content provider's server, and in case of an audio/video call or a voice-over-internet-protocol call, an other terminal etc. Then the service-selection-application in terminal 1 and/or coupling-interface 2 acknowledges the establishment to the service-selection-server 9 and/or to access system 4 (Block 108). Block 107 possibly together with block 108 form step (d) of, at said terminal 1 and/or coupling-interface 2, communicating with said providing-server 6 via at least one coupling 3 defined by at least one service parameter.

The (packet/cell/frame) signals (to be) exchanged between said terminal 1 and/or coupling-interface 2 and said providing-server 6 are billed (Block 109), which forms step (e).

With the permanent channel being present between coupling-interface 2 and service-selection-server 9, like for example an always-on-channel etc. which may form part of couplings 3 or not, and which may flow via access system 4 or not, step (d) may comprise the steps (d1) of, at said terminal 1 and/or said coupling-interface 2, in dependence of said service-information-signal, configuring parts of said terminal 1 and/or of said coupling interface 2, and (d2) of, at said terminal 1 and/or said coupling-interface 2, setting up a virtual connection from said coupling-interface 2 to said access system 4, and (d3) of, at said access system 4, setting up a virtual connection from said access system 4 to said providing-server 6, and with said service parameter being supplied to said terminal 1 and/or said coupling-interface 2 via said service-information-signal.

By introducing step (a), a user at the terminal 1 has got the option of selecting one out of many services, like for example surfing the web, making a telephone call, ordering pay-tv-channels etc. With step (b), parts of the access system 4, like for example modems, filters, (de)modulators, (de)converters etc. for example located in transceivers 47 and parts of couplings 3 like for example Asynchronous-Transfer-Mode-Pipes, Multi-Protocol-Label-Systems, Internet-Protocol-couplings etc. are configured to be in conformance with said service-definition-signal. By introducing step (c), the terminal 1 and/or the coupling-interface 2 is/are informed through the service-information-signal, which for example defines the coupling 3 etc. to be used. Finally, with step (d), signals for example comprising at least one service parameter are exchanged via the coupling 3 defined by the service parameter.

At the hand of said service-selection-signal, said service-definition-signal, said configuring and said service-information-signal, services can be selected dynamically and are specified dynamically (by the service-definition-signal), and the networks are used efficiently (said configuring allows for example couplings 3 etc. to be adapted with respect to bandwidth, delay, jitter, priority etc.), with the service-information-signal being used for informing the terminal 1 and/or the coupling-interface 2 dynamically and for increasing the efficiency of the terminal 1 and/or the coupling-interface 2.

Parts of the terminal 1 and/or coupling-interface 2 like for example modems, filters, (de)modulators, (de)converters etc. for example located in transceivers 17 and/or 27 are configured to be in conformance with said service-definition-signal. And said service parameter can be supplied to said terminal 1 and/or coupling-interface 2 via said service-information-signal.

Said (packet/cell/frame) signals (to be) exchanged may comprise addresses like for example an Internet-Protocol-Address or a Multi-Protocol-Layer-System-Address or a Local-Area-Network-Address etc. Said network 5 may be for example be an Internet-Protocol-Network or a Multi-Protocol-Layer-System-Network or a Local-Area-Network etc. Said service parameter may be for example an Asynchronous-Transfer-Mode-Quality-of-Service parameter or a non-Asynchronous-Transfer-Mode-Quality-of-Service parameter or an Internet-Protocol service parameter or a Multi-Protocol-Layer-System service parameter or a Local-Area-Network service parameter etc. Said couplings 3 and network 5 may coincide and form one new network, and said direct coupling between transceivers 67 and 97 may form part of network 5 or not. Transceivers 67 and 97 each comprise for example a (de)multiplexer and/or a mini-switch and/or a mini-bridge and/or a mini-router and/or a mini-forwarder etc. for being able to transmit and receive via one out of two outgoing and incoming couplings, with for example said processor-systems 60 and 90 taking care of the proper addressing and controlling etc.

In the method according to the invention shown in FIG. 3 in flow chart form for a non-permanent channel being present between coupling-interface 2 and service-selection-server 9 the blocks have the following meaning:

Block 200: A user at terminal 1 selects a service via a service-selection-application in terminal 1.

Block 201: The service-selection-application in terminal 1 either consults memory 18 or generates the service-definition-signal itself.

Block 202: The service-selection-application in terminal 1 informs the Asynchronous-Transfer-Mode-Termination-Point in terminal 1 about the configuration.

Block 203: The Asynchronous-Transfer-Mode-Termination-Point sets up one or more virtual connections from terminal 1 to service-selection-server 9.

Block 204: The service-selection-application in terminal 1 informs the service-selection-server 9 via said one or more virtual connections set up via for example couplings 3.

Block 205: The service-selection-server 9 consults either its own memory or a third party located elsewhere to be reached via couplings 3 or via network 5.

Block 206: The service-selection-server 9 retrieves user data originating from terminal 1 and/or from its own memory and/or from memory 48 and/or from another location to be reached via couplings 3 or via network 5 for authentication and/or authorisation purposes.

Block 207: The service-selection-server 9 configures access system 4 and/or couplings 3 and/or coupling-interface 2.

Block 208: The Asynchronous-Transfer-Mode-Termination-Point and/or access system 4 set up one or more virtual connections from access system 4 to a providing-server 6.

Block 209: Signals (to be) exchanged between said terminal 1 and said access system 4 are billed.

The method according to the invention shown in FIG. 3 and in view of the system shown in FIG. 1 functions in line with the description of the method shown in FIG. 2. In addition, with a non-permanent channel being present between coupling-interface 2 and service-selection-server 9, like for example a Plain-Ordinary-Telephony-System Connection, which may form part of couplings 3 or not and which may flow via access system 4 or not, step (a) may comprise the steps (a1) of, at said terminal 1 and/or said coupling-interface 2, in dependence of said service-selection-signal (which for example refers to an old service-definition-signal used before or to a predefined service-definition-signal to be used for said setting up etc.), setting up a virtual connection from said coupling-interface 2 to said service-selection-server 9 via for example couplings 3 and (a2) of, at said terminal 1 and/or said coupling-interface 2, in dependence of said service-selection-signal, configuring parts of said terminal 1 and/or said coupling-interface 2, and step (d) may comprise the step (d3) of, at said access system 4, setting up a virtual connection from said access system 4 to said providing-server 6, and with said service parameter being prestored in said terminal 1 and/or said coupling-interface 2. Further, step (d) may comprise the step (d4) of, at said terminal 1 and/or said coupling-interface 2, in dependence of said service-information-signal, re-configuring parts of said terminal 1 and/or of said coupling-interface 2, for example to adapt said old service-definition-signal used before or said predefined service-definition-signal to be used for said setting up etc.).

Parts of the terminal 1 and/or coupling-interface 2 like for example modems, filters, (de)modulators, (de)converters etc. for example located in transceiver 17 and/or 27 are configured to be in conformance with said service-selection-signal. Thereby, said service parameter will be prestored in said terminal 1 and/or coupling-interface 2.

Access processor-system 40 comprises processor-system-parts 41-46, with part 41 for example being a (a) receiving processor-system-part 41 for receiving a configuration-signal from said service-selection-server 9, and with part 42 for example being a (b) configuring processor-system-part 42 for, in dependence of said configuration-signal, configuring at least parts of said access system 4 and at least parts of said couplings 3. Part 43 for example is a (c) generating/forwarding processor-system-part 43 for generating/forwarding a service-information-signal and transmitting said service-information-signal to said terminal 1, with part 44 for example being a (b1) generating processor-system-part 44 for generating said service-definition-signal, and with part 45 for example being a receiving processor-system-part 45 for receiving said service-definition-signal from said providing-server 6 defined by said service-selection-signal, and with part 46 for example being a (d3) setting-up processor-system-part for setting up a virtual connection from said access system 4 to said providing-server 6 via said network 5.

Service-selection-server processor-system 90 comprises processor-system-parts 91-96, with part 91 for example being a (a) receiving processor-system-part 91 for receiving (100, 101) a service-selection-signal from said terminal 1, with part 92 for example being a (b) configuring processor-system-part 92 for, in dependence of a service-definition-signal, generating a configuration-signal and transmitting said configuration-signal to said access system 4 for configuring (104) at least parts of said access system 4 and at least parts of said couplings 3, and with part 93 being a (c) generating processor-system-part 93 for generating a service-information-signal and transmitting (105) said service-information-signal to said terminal 1.

Terminal processor-system 10 comprises processor-system-parts 11-16, with part 11 for example being a (a) selecting processor-system-part 11 for generating a service-selection-signal and transmitting (100, 101) said service-selection-signal from said terminal 1 to said service-selection-server 9, with part 12 for example being a (c) receiving processor-system-part 12 for receiving (105) a service-information-signal from said service-selection-server (9), and with part 13 for example being a (d) communicating processor-system-part 13 for communicating (107, 108) with said providing-server 6 via at least one coupling 3 defined by at least one service parameter. Part 14 may for example is a (d1) or (a2) configuring processor-system-part for, in dependence of said service-information-signal, configuring parts of said terminal 1 and/or of said coupling interface 2. Part 15 may for example be a (d2) or (a1) setting-up processor-system-part for setting up a virtual connection from said coupling-interface 2 to said access system 4.

Coupling-interface processor-system 20 comprises processor-system-parts 21-26, with part 21 for example being a (a) transceiving processor-system-part 21 for receiving a service-selection-signal from said terminal 1 and transmitting said service-selection-signal to said service-selection-server 9, with part 22 for example being a (c) receiving processor-system-part 22 for receiving a service-information-signal from said service-selection-server 9, and with part 23 for example being a (d) communicating processor-system-part 13 for communicating (107, 108) with said providing-server 6 via at least one coupling 3 defined by at least one service parameter. Part 24 may for example be a (d1) or (a2) configuring processor-system-part for, in dependence of said service-information-signal, configuring parts of said terminal 1 and/or of said coupling interface 2. Part 25 may for example be a (d2) or (a1) setting-up processor-system-part for setting up a virtual connection from said coupling-interface 2 to said access system 4.

Providing-server processor-system 60 comprises processor-system-parts 61-66, with part 61 for example being a (f1) receiving processor-system-part 61 for receiving a request signal or a service-selection-signal from service-selection-server 9, with part 62 for example being a (f2) generating processor-system-part 62 for, in response to said request signal or said service-selection-signal, generating a service-definition-signal, with part 63 for example being a (f3) transmitting processor-system-part 63 for transmitting said service-definition-signal to said service-selection-server 9, and with part 64 for example being a (f4) communicating processor-system-part for communicating (107, 108) with said terminal 1 via at least one coupling 3 defined by at least one service parameter.

The expression “for” in for example “for exchanging” and “for providing” etc. does not exclude that other functions are performed as well, simultaneously or not. The expressions “X coupled to Y” and “a coupling between X and Y” and “coupling/couples X and Y” etc. do not exclude that an element Z is in between X and Y. The expressions “P comprises Q” and “P comprising Q” etc. do not exclude that an element R is comprises/included as well. The terms “a” and “an” do not exclude the possible presence of one or more pluralities. More than one coupling-interface 2 may be present between terminal 1 and access system 4. Permanent channel 3 or non-permanent channel 3 may coincide with packet-switched-couplings 3 or not in which case it may be a completely different coupling. The Asynchronous-Transfer-Mode-Termination-Point discussed at the hand of FIGS. 2 and 3 is just an example and may alternatively be an Multi-Protocol-Layer-System-Termination-Point or a Local-Area-Network-Termination-Point etc. Correspondingly, the term Asynchronous-Transfer-Mode used in this description is just an example and may alternatively be an Multi-Protocol-Layer-System or a Local-Area-Network etc.

The invention is based upon an insight, inter alia, that prior art services are selected statically and are specified statically, and prior art networks are used inefficiently, and is based upon a basic idea, inter alia, said service-selection-signal, said service-definition-signal, said configuring and said service-information-signal are to be introduced.

The invention solves the problem, inter alia, of providing a more dynamical and more efficient method, and is advantageous, inter alia, in that services can be selected dynamically and are specified dynamically, and the networks are used efficiently, and the terminal and/or the coupling-interface is/are informed dynamically and is/are made more efficient.

1. Method for communication between a terminal (1) with a coupling-interface (2) and a providing-server (6) via couplings (3) for providing services defined by service parameters and via an access system (4) for accessing a network (5), characterised in that said method comprises the steps of
(a) at said terminal (1), generating a service-selection-signal and transmitting said service-selection-signal (100, 101) from said terminal (1) to a service-selection-server (9),
(b) at said service-selection-server (9), in dependence of a service-definition-signal, generating a configuration-signal and transmitting said configuration-signal to said access system (4) for configuring (104) at least parts of said access system (4) and at least parts of said couplings (3),
(c) at said service-selection-server (9), generating a service-information-signal and transmitting said service-information-signal (105) to said terminal (1) and/or said coupling-interface (2), and
(d) at said terminal (1) and/or said coupling-interface (2), communicating (107, 108) with said providing-server (6) via at least one coupling (3) defined by at least one service parameter.

2. Method according to claim 1, characterised in that said step (b) comprises the step of (b1) at said service-selection-server (9), in dependence of said service-selection-signal, generating said service-definition-signal.

3. Method according to claim 1, characterised in that said step (b) comprises the step of (b2) at said service-selection-server (9), receiving said service-definition-signal from said providing-server (6) defined by said service-selection-signal.

4. Method according to claim 1, 2 or 3, characterised in that said coupling-interface (2) is coupled to a permanent channel, with said step (d) comprising the steps of (d1) at said terminal (1) and/or said coupling-interface (2), in dependence of said service-information-signal, configuring at least parts of said terminal (1) and/or of said coupling interface (2), and of (d2) at said terminal (1) and/or said coupling-interface (2), setting up a virtual connection from said coupling-interface (2) to said access system (4), and of (d3) at said access system (4), setting up a virtual connection from said access system (4) to said providing-server (6), and with said service parameter being supplied to said terminal (1) and/or said coupling-interface (2) via said service-information-signal.

5. Method according to claim 1, 2 or 3, characterised in that said coupling-interface (2) is not coupled to said access system (4) via a permanent channel, with said step (a) comprising the steps of (a1) at said terminal (1) and/or said coupling-interface (2), in dependence of said service-selection-signal, setting up a virtual connection from said coupling-interface (2) to said service-selection-server (9) and of (a2) at said terminal (1) and/or said coupling-interface (2), in dependence of said service-selection-signal, configuring at least parts of said terminal (1) and/or said coupling-interface (2), and with said step (d) comprising the step of (d3) at said access system (4), setting up a virtual connection from said access system (4) to said providing-server (6), and with said service parameter being prestored in said terminal (1) and/or said coupling-interface (2).

6. Method according to claim 5, characterised in that said step (d) comprises the step of (d4) at said terminal (1) and/or said coupling-interface (2), in dependence of said service-information-signal, re-configuring at least parts of said terminal (1) and/or of said coupling-interface (2).

7. Method according to any one of claims 1 to 6, characterised in that said method comprises the step of (e) at said access system (4), billing packet-signals (to be) exchanged (109) between said terminal (1) and/or of said coupling-interface (2) on the one hand and said providing-server (6) on the other hand.

8. Access system (4) for performing a method for communication between a terminal (1) with a coupling-interface (2) and a providing-server (6) via couplings (3) for providing services defined by service parameters and via said access system (4) for accessing a network (5), which access system (4) comprises an access processor-system (40) for controlling an access tranceiver (47) for transmitting and receiving signals, characterised in that said access processor-system (40) comprises
(a) a receiving processor-system-part (41) for receiving a configuration-signal from said service-selection-server (9), and
(b) a configuring processor-system-part (42) for, in dependence of said configuration-signal, configuring (104) at least parts of said access system (4) and at least parts of said couplings (3).

9. Access processor program product to be run via an access processor-system (40) for controlling an access tranceiver (47) for transmitting and receiving signals and for use in an access system (4) for performing a method for communication between a terminal (1) with a coupling-interface (2) and a providing-server (6) via couplings (3) for providing services defined by service parameters and via said access system (4) for accessing a network (5), characterised in that said access processor program product comprises the functions of
(a) receiving a configuration-signal from said service-selection-server (9), and
(b) in dependence of said configuration-signal, configuring (104) at least parts of said access system (4) and at least parts of said couplings (3).

10. Service-selection-server (9) for performing a method for communication between a terminal (1) with a coupling-interface (2) and a providing-server (6) via couplings (3) for providing services defined by service parameters and via an access system (4) for accessing a network (5), which service-selection-server (9) comprises a service-selection-server processor-system (90) for controlling a service-selection-server tranceiver (97) for transmitting and receiving signals, characterised in that said service-selection-server processor-system (90) comprises
(a) a receiving processor-system-part (91) for receiving (100, 101) a service-selection-signal from said terminal (l),
(b) a configuring processor-system-part (92) for, in dependence of a service-definition-signal, generating a configuration-signal and transmitting said configuration-signal to said access system (4) for configuring (104) at least parts of said access system (4) and at least parts of said couplings (3), and
(c) a generating processor-system-part (93) for generating a service-information-signal and transmitting (105) said service-information-signal to said terminal (1).

11. Service-selection-server program product to be run via a service-selection-server processor-system for controlling a service-selection-server tranceiver for transmitting and receiving signals and for use in a service-selection-server (9) for performing a method for communication between a terminal (1) with a coupling-interface (2) and a providing-server (6) via couplings (3) for providing services defined by service parameters and via an access system (4) for accessing a network (5), characterised in that said service-selection-server program product comprises the functions of
(a) receiving (100, 101) a service-selection-signal from said terminal (l),
(b) in dependence of a service-definition-signal, generating a configuration-signal and transmitting said configuration-signal to said access system (4) for configuring (104) at least parts of said access system (4) and at least parts of said couplings (3), and
(c) generating a service-information-signal and transmitting (105) said service-information-signal to said terminal (1).

12. Terminal (1) for performing a method for communication between said terminal (1) with a coupling-interface (2) and a providing-server (6) via couplings (3) for providing services defined by service parameters and via an access system (4) for accessing a network (5), which terminal (1) comprises a terminal processor-system (10) for controlling a terminal tranceiver (17) for transmitting and receiving signals, characterised in that said terminal processor-system (10) comprises
(a) a selecting processor-system-part (11) for generating a service-selection-signal and transmitting (100, 101) said service-selection-signal from said terminal (1) to said service-selection-server (9),
(c) a receiving processor-system-part (12) for receiving (105) a service-information-signal from said service-selection-server (9), and
(d) a communicating processor-system-part (13) for communicating (107, 108) with said providing-server (6) via at least one coupling (3) defined by at least one service parameter.

13. Terminal processor program product to be run via a terminal processor-system (10) for controlling a terminal tranceiver (17) for transmitting and receiving signals and for use in a terminal (1) for performing a method for communication between said terminal (1) with a coupling-interface (2) and a providing-server (6) via couplings (3) for providing services defined by service parameters and via an access system (4) for accessing a network (5), characterised in that said terminal processor program product comprises the functions of
(a) generating a service-selection-signal and transmitting (100, 101) said service-selection-signal from said terminal (l) to said service-selection-server (9),
(c) receiving a service-information-signal from said service-selection-server (9), and
(d) communicating (107, 108) with said providing-server (6) via at least one coupling (3) defined by at least one service parameter.

14. Coupling-interface (2) for performing a method for communication between a terminal (1) with said coupling-interface (2) and a providing-server (6) via couplings (3) for providing services defined by service parameters and via an access system (4) for accessing a network (5), which coupling-interface (2) comprises a coupling-interface processor-system (20) for controlling a coupling-interface tranceiver (27) for transmitting and receiving signals, characterised in that said coupling-interface processor-system (20) comprises
(a) a transceiving processor-system-part (21) for receiving a service-selection-signal from said terminal (1) and transmitting (100, 101) said service-selection-signal to said service-selection-server (9),
(c) a receiving processor-system-part (22) for receiving (105) a service-information-signal from said service-selection-server (9), and
(d) a communicating processor-system-part (23) for communicating (107, 108) with said providing-server (6) via at least one coupling (3) defined by at least one service parameter.

15. Coupling-interface processor program product to be run via a coupling-interface processor-system (20) for controlling a coupling-interface tranceiver (27) for transmitting and receiving signals and for use in a coupling-interface (2) for performing a method for communication between a terminal (1) with said coupling-interface (2) and a providing-server (6) via couplings (3) for providing services defined by service parameters and via an access system (4) for accessing a network (5), characterised in that said coupling-interface processor program product comprises the functions of
(a) receiving a service-selection-signal from said terminal (1) and transmitting (100, 101) said service-selection-signal to said service-selection-server (9),
(c) receiving (105) a service-information-signal from said service-selection-server (9), and
(d) communicating (107, 108) with said providing-server (6) via at least one coupling (3) defined by at least one service parameter.

16. Providing-server (6) for use in a method for communication between a terminal (1) with a coupling-interface (2) and said providing-server (6) via couplings (3) for providing services defined by service parameters and via an access system (4) for accessing a network (5), which providing-server (6) comprises a providing-server processor-system (60) for controlling a providing-server tranceiver (67) for transmitting and receiving signals, characterised in that said providing-server processor-system (60) comprises
(f1) a receiving processor-system-part (61) for receiving a request signal or a service-selection-signal from a service-selection-server (9),
(f2) a generating processor-system-part (62) for, in response to said request signal or said service-selection-signal, generating a service-definition-signal,
(f3) a transmitting processor-system-part (63) for transmitting said service-definition-signal to said service-selection-server (9), and
(f4) a communicating processor-system-part (64) for communicating (107, 108) with said terminal (1) via at least one coupling (3) defined by at least one service parameter.

17. Providing-server processor program product to be run via a providing-server processor-system (60) for controlling a providing-server tranceiver (67) for transmitting and receiving signals and for use in a providing-server (6) for performing a method for communication between a terminal (1) with a coupling-interface (2) and said providing-server (6) via couplings (3) for providing services defined by service parameters and via an access system (4) for accessing a network (5), characterised in that said providing-server processor program product comprises the functions of
(f1) receiving a request signal or said service-selection-signal from a service-selection-server (9),
(f2) in response to said request signal or said service-selection-signal, generating a service-definition-signal,
(f3) transmitting said service-definition-signal to said service-selection-server (9), and
(f4) communicating (107, 108) with said terminal (1) via at least one coupling (3) defined by at least one service parameter.
